(19) United States
(12) Patent Application Publication
(10) Pub. No.: US 2018/0101153 A1
(43) Pub. Date: Apr. 12, 2018

(54) AUTOMATED DWELLING CONTROL SYSTEM

(71) Applicant: David Vazquez, San Jacinto, CA (US)

(72) Inventor: David Vazquez, San Jacinto, CA (US)

(21) Appl. No.: 15/728,377

(22) Filed: Oct. 9, 2017

Related U.S. Application Data
(60) Provisional application No. 62/405,770, filed on Oct. 7, 2016.

(51) Int. Cl. G05B 19/042; G06Q 40/08

(52) U.S. Cl. CPC G05B 19/042; G05B 2219/25011; G06Q 40/08

(57) ABSTRACT

A system for controlling the operation of utilities such as power, water, gas and communications in a building. The system includes a software component that is uploaded onto a mobile communications device such as a cell phone, smart phone, tablet etc. that communicates with at least one utility control devices that enable and disable the utility service to the building based upon the mobile communications device being in proximity to the building.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

The present invention relates to utility systems for dwellings and other buildings and, in particular, a system for controlling the operation of water, power and gas systems in a building.

### Description of the Related Art

Buildings, such as offices and dwellings have utility systems that include power, water and gas. These provide essential services for the occupants of the dwelling but these systems can fail. Electrical systems can short circuit and water and gas pipes can break. These systems can even have less catastrophic failures, e.g., leaking faucets and unnecessary electrical appliances left on that can increase the cost to the occupant of the dwelling. When these failures occur when the building is occupied, the occupant usually notices the problem and can take corrective action.

However, if these failures occur when the building is not occupied, then the failure can result in greater cost to the owner of the building and can even result in significant damage to the building itself. For example, a broken water pipe in a house may result in significant flooding if it occurs for a long period of time when the occupant of the building is not present. Similarly, an appliance such as an electric or gas stove left on while the occupant is away can also result in potential danger to the dwelling or, at the very least, result in significant increase in the utility bill of the occupant of the building.

One way to manage the risk associated with utility systems failing when the occupant is not present is to manually turn off some or all of the utility systems when the occupant leaves the building. This may require the occupant to flip one or more circuit breakers and manually turn off the water and gas systems. The manual nature of this approach deters many occupants of building from disabling the systems. Automated turn off systems have been contemplated but these systems are generally not user friendly and require specialized equipment and components to be carried by the occupants which increase the expense and limit their use by occupants.

From the foregoing, there is a need for a system for disabling part or all of a building's utility systems that is automated and is integrated with components and devices that occupants of buildings already have. To this end, there is a need for a system that can be configured to automatically turn off some or all of water, gas and electrical systems upon an occupant leaving a building and then turning on the systems when the occupant returns without significant steps needing to be taken by the occupant.

### SUMMARY OF THE INVENTION

The foregoing needs are addressed, in at least one exemplary embodiment by the automated system of the present invention that comprises at least one automated control device for at least one utility system for a dwelling that are electrically activated so as to be able to selectively enable and disable the utility system. The automated system further includes an application resident on an occupant of the dwelling's modular communications device that enables the modular communications device to send a signal to enable and disable the at least one utility system.

In one particular implementation, the at least one automated control device includes a transceiver, such as an RF transceiver that communicates with a transceiver that is resident on the occupant's modular communications device. When the at least automated control device detects the presence of the modular communications device via signal exchange, the utility system is enabled. When the at least one automated shut off device no longer detects the presence of the modular communications device via signal exchange, the utility system is disabled thereby lessening the risk of total or partial failure of the system in the absence of the occupant of the dwelling.

In one particular implementation, the at least one utility system can include electrical, water, gas or communications systems or a combination of such systems. In one particular implementation, the modular communications device can comprise a cell phone or smart phone with a downloaded application that induces the phone to send an RF signals to the automated shut off system. In one implementation, the system can be configured so that only part of a utility system is automatically turned off such that equipment or devices that need to operate in the absence of the occupant can remain on. In one implementation, the at least one automated control device includes a manual override system that allows the occupant to enable or disable the system without their personal communications device.

In one implementation, the automated control device is responsive to the presence of more than one personal communications device thereby allowing a plurality of occupants or persons to enable and disable the system. In this implementation, the at least one automated control device is configured to enable the at least one utility system when at least one of the plurality of personal communications is detected as being present.

These and other objects and advantages of the present invention will become more apparent from the following description taken in conjunction with the accompanying drawings.

### BRIEF DESCRIPTION OF THE DRAWINGS

FIG. 1 is a simplified block diagram of one exemplary embodiment of a utility control system for a building;

FIG. 2 is a simplified block diagram illustrating the communications system of the control system of FIG. 1;

FIG. 3 is a simplified schematic illustrating one exemplary embodiment of a valve control system of the system of FIG. 1;

FIG. 4 is a simplified schematic illustrating one exemplary embodiment of a circuit breaker of the system of FIG. 1; and

FIG. 5 is a simplified flow chart illustrating an exemplary operation of the system of FIG. 1.

### DETAILED DESCRIPTION OF THE PREFERRED EMBODIMENT

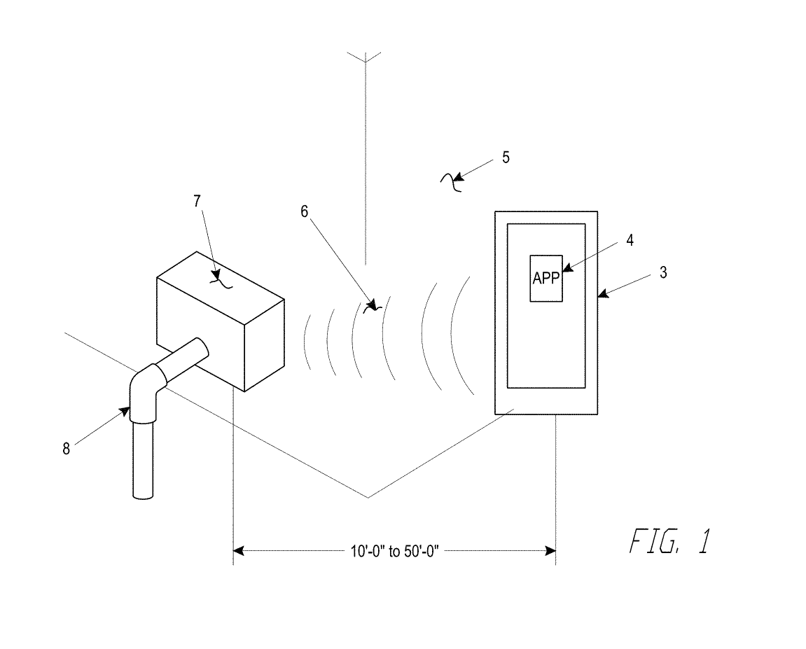

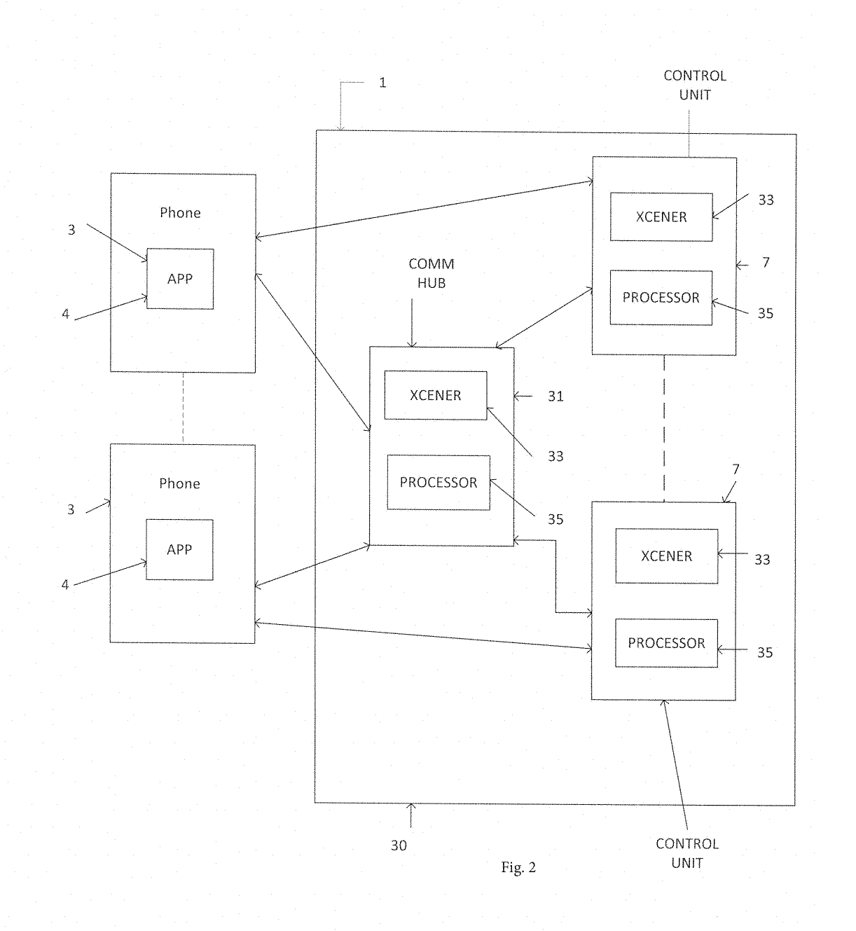

Reference will now be made to the drawings wherein like numerals refer to like parts throughout. Referring initially to FIGS. 1 and 2, an exemplary utility control system 1 of the instant application is illustrated. As shown, the system 1 includes a mobile communications device 3 that can, in one non-limiting example, be a mobile phone such as a smart phone. In this implementation, the device included downloaded software in the form of an application or app that induces the phone to transmit a signal, such as an RF signal. The app 4 can induce the phone 3 to transmit the signal periodically or in response to the receipt of a signal from a nearby utility control device 5 in the manner that will be described in greater detail below.

The utility control device 5 is a device that is positioned on a utility line, such as an electrical power line, a gas line, a water line, a communications line or any other type of utility system that is being provided to a building, dwelling or enclosed structure that is receiving the utility services. As will be described in greater detail below, the utility control device 5 includes a transceiver and a processor that enables the utility control device 5 to selective enable and disables the utility service in response to detecting the presence of the mobile communications device 3 in a pre-determined proximity of the utility control device 5.

In one implementation, the utility control device 5 detects the strength of the signal received from the mobile device 3 to determine whether an occupant is within range of the device to thereby enable the utility service. In one implementation, the system can be configured to detect the presence of the mobile device to within 10 to 50 feet but these distances can vary without departing from the spirit and scope of the present teachings.

In one specific implementation, the utility control device 5 and the mobile device 3 communicate with each other via RF signals such as Blue Tooth signals or other signaling protocols. This type of communication makes the system independent of the existence of the Internet. In other applications though, the system 1 can communicate between the mobile device 3 and the utility control device 7 via the Internet or other local communications networks. In other applications, the communications between the mobile device 3 and the control device 7 can be performed using any of a number of redundant communications protocols including WI, FI, other internet signals intranet and RF signals to ensure the smooth enablement and disablement of the utility services.

As shown in FIG. 2, there can be more than one mobile device 3 that can be used to activate the utility control devices 7. In one implementation, the utility control devices 7 are set to enable the utility services if any one of the mobile devices 3 are present. If all are not present, in this one implementation, then the utility services are disabled. It will be appreciated, however, that those may make various modifications as to the use of multiple mobile devices skilled in the art without departing from the scope of the present teachings.

Further, FIG. 2 also illustrates that the communications between the utility control devices 7 and the mobile devices 3 can either be direct, or can be indirect via a communications hub. The utility control devices 7 can be equipped with a transceiver 33 that permits direct communications with the mobile devices via RF signals, WI FI signals, internet signals and the like as discussed above. The utility control devices 7 may also be equipped with processors 35 that enable the device to determine if a mobile device 3 is in proximity to enable the utility and also to permit customization of the utility service. It may be that various parts of the utility service may be enabled and disabled by the proximity of a mobile device 3, e.g., some electrical circuits may remain on at all times while others are enabled and disabled in the presence of the mobile device. As a consequence, the mobile device 7 is preferably programmable by the occupant(s) of the dwelling in a known manner.

As will be discussed in greater detail below, the utility control devices 7 also include manual overrides that permit the occupant of the dwelling to enable or disable the utility services in the absence of the communication between the mobile device 3 and the utility control device 7. It will be appreciated that neither forgotten nor non-working mobile devices 3 may occur and providing the occupant with the manual ability to enable the utility services is advantageous.

As is also shown in FIG. 2, the system 1 may be configured so that the mobile devices 3 communicate with a communications hub 31 that has a transceiver 33 and a processor 35. The communications hub 31 may be designed to have better communications capability than individual utility control devices 7 and receive and retransmit signals between the utility devices 7 and the mobile devices 3. The hub 31 may also be mounted in a better location to detect the presence of the mobile device(s) 3 than utility control devices 7 that may be located in under floor storage spaces or other remote locations. The hub 31 may be configured to broadcast stronger signals to facilitate communications between the mobile devices 3 and the utility control devices 7.

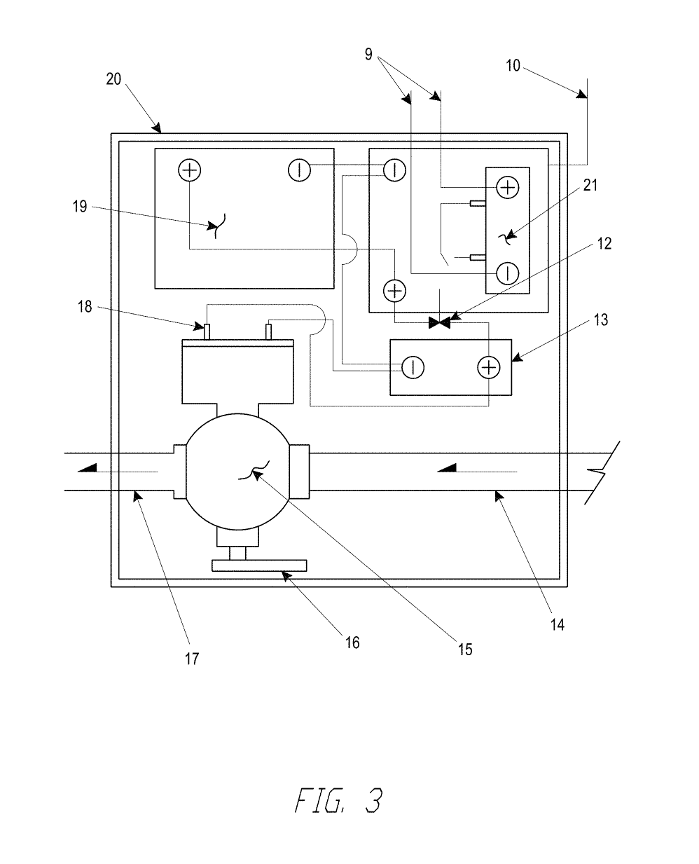

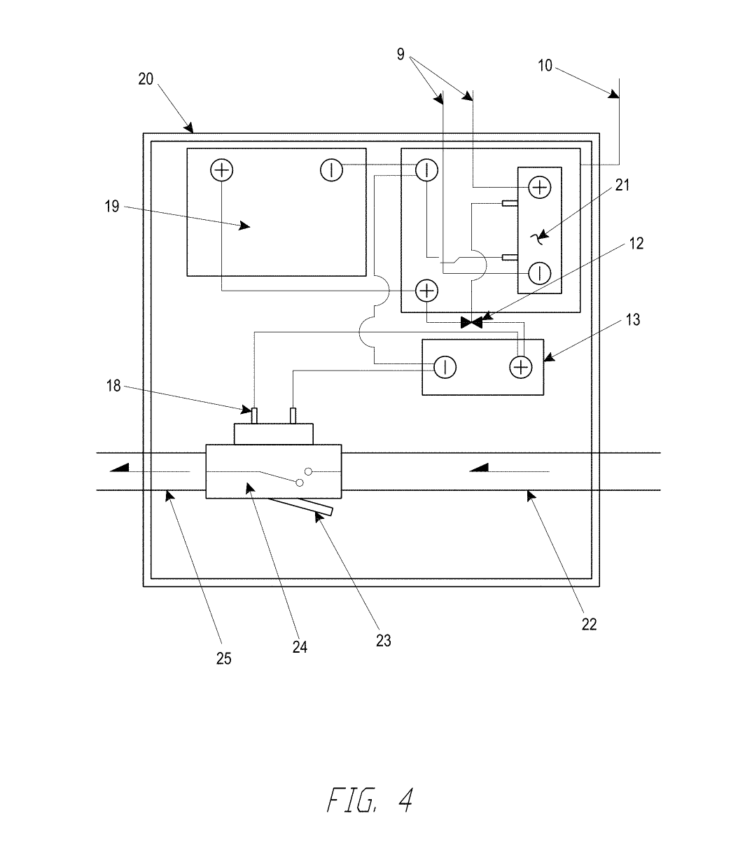

Specific, non-limiting implementations of the utility control devices 7 will now be described in conjunction with FIGS. 3 and 4. Referring initially to FIG. 3, a water or gas utility control device 7 is shown in schematic detail. In this implementation, a motorized valve 15 is placed in the gas or water line between the inlet 14 and the outlet 17. As shown, the valve 15 includes a manual shut off 16 that enables manual control of the valve. In this implementation, power is provided at 9 to a transformer 21 that reduces the building's power 9 from 110 volts to 24 volts. The system is connected via an inline fuse 12. The device 7 is preferably positioned within a suitable enclosure that can be mounted on either an interior or exterior wall of the building. The device 7 also includes a back up power system 19 that permits operation of the device 7 in the absence of 110-volt power via the power lines 9.

The device 7 of FIG. 3 also includes an antenna 10 or other input that provides signals to a close proximity sensor 11 that induces the delivery of the 24-volt output of the transformer 21 to the input 18 of the motorized valve causing the valve to either open or close depending upon the configuration of the signal. The signal can either be a directly received RF signal or it can be a signal that is processed by the processor 35 in the manner described above.

Referring now to FIG. 4, an exemplary utility control device 7 for controlling the delivery of electrical signals, or potentially hard-wired communications signals, is shown. The device 7 is similar in configuration to the device 7 discussed above in connection with FIG. 3 except that an electrically operable switch 24 to disconnect the electrical power or communication line between an inlet 22 and an outlet 25 is disclosed. Similar to the previously described device, there's an antenna 10 or other signal transmitting device 10 that provides a signal to a close proximity sensor 11 that then provides power from a transformer 21 to a relay switch 13 and the electrical switch 24 to enable and disable power on the power line 22, 25. The electrical switch 24 also includes a manual override 23 that allows the user to manually enable and disable the electrical or communications system.

Power is provided via the hard wired power lines 9 and is converted by the transformer 21 to 24 volts, which is then provided to the proximity sensor 13 and the switch 24. The device 7 also includes a backup power system 19 and is housed in a housing 20 in the same manner as described above.

It will be appreciated that the devices 7 of FIGS. 3 and 4 are simply exemplary and that other configurations of devices can be used without departing from the spirit or scope of the present teachings. The circuitry can, for example, be controlled via a processor-controlled switch that communicates with a transceiver to determine whether to enable or disable the utility service due to the proximity of the mobile device(s).

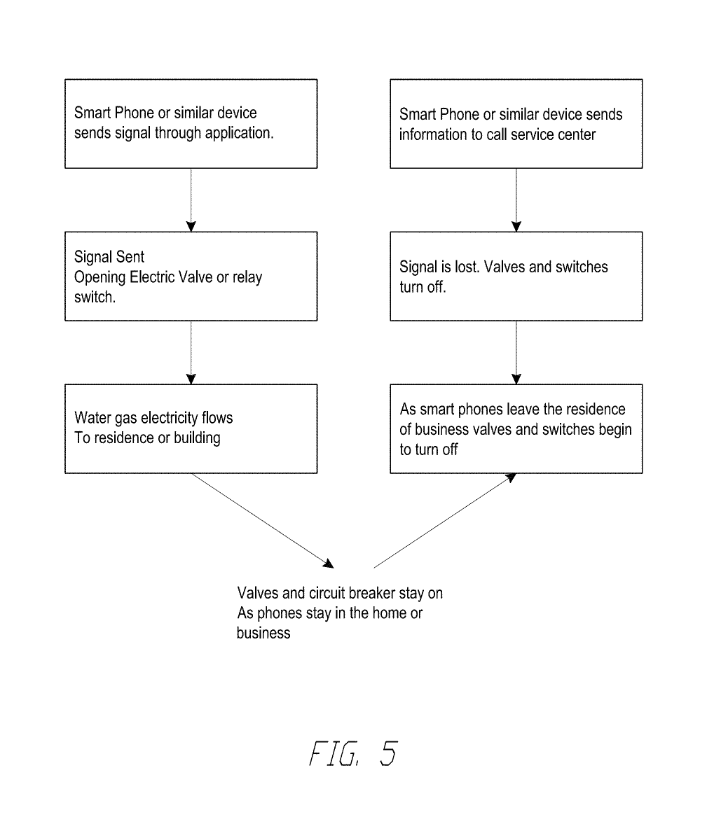

FIG. 5 is an exemplary flow chart illustrating the operation of the system 1 as it enables and disables utility and potentially communications services to the building. The exact operational flow of the system 1 will, of course, vary depending upon implementation and FIG. 5 is simply illustrative of the basic operation of the system. As shown, the system 1 works with the mobile device 3 and either the utility control device 7 or the comm hub 31 communicating with each other. The utility control device 7 is enabled when the mobile device 3 is sensed to be in proximity to the utility control device 7. This determination can be done by either the utility control device 7 or a central processor such as a processor in a communications hub as discussed above.

When the mobile device(s) 3 are in proximity, then utility services are enabled in the building and will continue to be enabled as long as the mobile device(s) 3 are in proximity to the building. As the mobile device(s) 3 leave the building, the signal is lost and the utility control devices 7 disable the utilities. The system 1 can also communicate the status of the building to a call service center such that central monitoring can also be accomplished. In one implementation, the central monitoring can be used to adjust insurance rates for the building. If the building has the system described herein, the risk of damage due to electrical short, gas leak or water leak is reduced and the insurance rates can be accordingly adjusted. The rates can also be adjusted based upon the actual use of the utilities as well.

Although the foregoing has shown, illustrated and described at least one implementation of the present invention, it will be apparent to those skilled in the art that various substitutions, modifications and changes to the uses thereof can be made to the described system and method without departing from the spirit and scope of the present invention. As such, the scope of the present invention should not be limited to the foregoing discussion but should be defined by the appended claims.

What is claimed is:

1. A building utility management system comprising:
a software component, installable on a mobile communication device; and
at least one utility control device that engages with a utility service provided to the building, wherein the software component communicates with the at least one utility control device via the mobile communications device such that the utility control device enables the utility service to the building when the mobile communications device is in proximity to the building and disables the utility when the mobile communications device is not in proximity to the building.

2. The system of claim 1, wherein the at least one utility control devices comprises a plurality of utility control devices that control the delivery of electricity, water, gas and communications services to the building.

3. The system of claim 2, wherein at least one of the plurality of utility control devices partially disables the delivery of the utility service in response to the mobile communications device not being in proximity to the building.

4. The system of claim 1, further comprises a communications hub that interconnects communications between the mobile communications device and the at least one utility control device.

5. The system of claim 1, wherein the utility control device includes a processor and a transceiver.

6. The system of claim 1, wherein the utility control device includes a manual override to permit operation of the device in the absence or malfunction of the mobile communications device.

7. The system of claim 1, wherein the utility control device includes a backup battery power system to permit operation of the utility control device in the absence of building power.

8. The system of claim 1, wherein the utility control device enables the utility in response to detecting that one of a plurality of mobile communications device, each having the downloadable component, is in proximity to the building.

9. The system of claim 8, wherein the utility control device disables the utility in response to none of the plurality of mobile communications devices being in proximity to the building.

10. The system of claim 1, wherein the utility control device includes a transformer, a proximity sensor that determines if the mobile communications device is proximate to the building, and a relay that actuates a switch or valve that is engaged with the utility.

11. The system of claim 1, wherein the mobile communication device communicates via RF signals to the at least one utility control device.

12. The system of claim 1, wherein the mobile communications device communicates via WI FI, internet, intranet or RF communications signals to the at least one utility control device.

13. The system of claim 12, wherein the mobile communications device and the at least one utility control device automatically cycles between WI FI, Internet, Intranet and RF communications modes in response to a lack of communications link on a particular mode.

14. A building monitoring system that determines the presence of at least one mobile device and enables at least one utility service upon determining the presence of at least one mobile device and wherein the building monitoring system disables the at least one utility service upon not determining the presence of at least one mobile device.

15. The system of claim 14, wherein the system communicates with the at least one mobile device via RF frequencies.

16. The system of claim 14, wherein the system partially disables at least one utility service in response to determining that at least one mobile device is not present.

17. The system of claim 14, wherein the system enables and disables power, water, gas or communications services.

18. The system of claim 14, wherein the system includes a downloadable component downloaded onto the mobile devices.

19. The system of claim 14, wherein the at least one mobile device comprises a cellular telephone.
